(19) United States
(12) Patent Application Publication
(10) Pub. No.: US 2006/0112978 A1
(43) Pub. Date: Jun. 1, 2006

(54) Apparatus and method for wet-treating wafers

(76) Inventor: Eung Jegal, Gyeonggi-do (KR)

Correspondence Address: MARGER JOHNSON & MCCOLLOM, P.C., 210 SW MORRISON STREET, SUITE 400, PORTLAND, OR, 97204, US

(21) Appl. No.: 11/271,423

(22) Filed: Nov. 9, 2005

(30) Foreign Application Priority Data
Nov. 26, 2004 (KR) 2004-97943

(51) Int. Cl. B08B 3/04

(52) U.S. Cl. 134/56 R; 134/76; 134/137; 134/164; 134/165

(57) ABSTRACT

An apparatus is provided for wet-treating wafers. This apparatus can comprise at least one wet treatment bath for wet treating a plurality of wafers. Further, it can include a wafer transfer device for moving the plurality of wet-treated wafers to the wet treatment bath and a wafer sensor for sensing data comprising the weight of the plurality of wet-treated wafers. Also, a controller can be provided for determining whether any of the plurality of wet-treated wafers supported by the wafer transfer device is damaged by comparing the data as sensed by the wafer sensor to data regarding a predetermined weight of a plurality of reference wafers.

### BACKGROUND OF THE INVENTION

This application claims the priority of Korean Patent Application No. 10-2004-0097943, filed on Nov. 26, 2004, in the Korean Intellectual Property Office, the disclosure of which is incorporated herein in its entirety by reference.

1. Field of the Invention

The present invention relates to an apparatus and a method for wet-treating wafers, and more particularly, to an apparatus and a method for wet-treating wafers in a wet treatment bath.

2. Description of the Related Art

In a process of manufacturing a semiconductor device, there can be a series of process steps in which a conductive layer, a semiconductor layer and an insulating layer are formed on a wafer by using various methods such as photolithography, etching, ashing, diffusion, chemical vapor deposition, ion implanting, and metal deposition. Further, a cleaning process after each unit process is performed to remove impurities remaining on the wafer, such as reaction by-products and dust particles.

As the semiconductor device is gradually high integrated, a cleaning technique to remove various pollutants on the wafer becomes more critical in the process of manufacturing the semiconductor device. In an apparatus for wet-treating wafers as currently used, chemicals of various kinds are employed depending on the pollution sources.

A wet cleaning apparatus can be classified as a single type or a batch type. The single type wet cleaning apparatus can be for processing a wafer one by one using chemicals. The batch type wet cleaning apparatus can be for processing a plurality of wafers at a time in a wet treatment bath. When any damage occurs on the wafer during the wet treatment, the single type apparatus rejects only one of the wafers. However, in the batch type apparatus, even though one the wafers is damaged, this may give rise to a large scale accident in which many other wafers are damaged and become unusable. Such a large scale accident is likely to happen when the next lot of wafers which is input into the wet cleaning bath and there are substandard wafer from the preceding lot of the wafers remaining in the wet treatment bath. That is, the defective wafers remaining in the wet treatment bath may cause damage, for example, to subsequent wafers, to the wet treatment bath or guide, or to the robot arm.

In a conventional batch type wet treatment apparatus, a wafer sensing device, such as a photo sensor including a light emitting unit and a light receiving unit is provided in a rinse bath. This conventional sensing device has the detection limitation in that a wafer or a piece of an irregularly shaped wafer remained in a rinse bath may not detected, depending on its position. Therefore, the conventional batch type apparatus has a problem because there is a detection limitation in the conventional sensing device which can lead to a large scale accident.

### SUMMARY

An object of the present invention is to solve the above problem by providing an apparatus for wet-treating wafers in a batch type wet treatment apparatus, in which it is possible to sense in early stages whether the wet treatment is progressed in the state that a wafer that is irregular is in a wet treatment bath for an etching, cleaning or rinse process of the wafers and to prevent the next lot of wafers from being input if any wafer which is irregular remains, thereby preventing any large scale accidents.

According to an aspect of the present invention, there is provided an apparatus for wet-treating wafers. This apparatus can comprise at least one wet treatment bath for wet treating a plurality of wafers. Further, it can include a wafer transfer device for moving the plurality of wafers to the wet treatment bath, and a wafer sensor for sensing data comprising the weight of the plurality of wet-treated wafers. Also, a controller can be provided for determining whether any of the plurality of wet-treated wafers supported by the wafer transfer device is damaged by comparing the data as sensed by the wafer sensor to data regarding a predetermined weight of a plurality of reference wafers.

The wafer transfer device preferably comprises a robot arm. The wafer sensor is preferably located adjacent to or connected to the wafer transfer device. The wafer sensor can comprise an electronic device mounted at a predetermined position with respect to the wafer transfer device for detecting the weight of a plurality of wet-treated wafers supported by the wafer transfer device while the wafer transfer device is moved. The wafer sensor preferably comprises a charge coupled device camera mounted at a predetermined position with respect to the wafer transfer device. Moreover, the wafer sensor can be mounted at a predetermined position above the wafer sensor.

The controller, after comparing the sensed data with the reference data, preferably generates an interlock signal. The wet treatment bath preferably comprises at least one of a chemical bath for etching a predetermined layer on the wafers and a cleaning bath for cleaning or rinsing the surface of the wafers.

A method is also provided for wet-treating wafers. The method comprises wet-treating a plurality of wafers in a wet treatment bath. Next, the wet-treated wafers are moved from the wet treatment bath, and data is sensed and generated as to whether the wet-treated wafers are damaged. Then, the relative condition of the wet-treated wafers is determined and it is ascertained as to whether they are damaged by comparing the data as sensed by the wafer sensor to data regarding the condition of reference pre-treated wafers. The method preferably determines the relative condition of the wet-treated wafers comprises detecting a change in the weight of the wafers as compared to the weight of the reference wet-treated wafers to detect whether the wafers are damaged of the wet-treated wafers.

The method preferably comprises detecting image data of the wet-treated wafers to detect whether the wet-treated wafers are damaged. A charge coupled device camera is preferably installed at a predetermined position to detect the image data. More preferably, a charge coupled device camera is installed at a predetermined position above the wet-treated wafers to detect the image data.

The method further includes an operation of ascertaining whether the pre-treated wafers are damaged further which comprises establishing a predetermined weight of wafers as reference data, sensing an actual weight of a plurality of wet-treated wafers, and comparing the actual weight as sensed to the reference data. The method can also include the operation of determining whether or not any troubles further comprises establishing predetermined image data of wafers as referenced data, sensing actual image data of the wet-treated wafers, and comparing the image data as sensed to the reference data. These methods can further comprise generating an interlock signal if the weight as sensed is beyond an allowable range as compared to the reference data.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of an apparatus for wet-treating wafers according to an embodiment of the present invention;

FIG. 2 is a schematic view specifically illustrating an apparatus for wet-treating wafers in which a portion of the apparatus for wet-treating wafers of FIG. 1 is illustrated in more detail; and

FIG. 3 is a schematic view an apparatus for wet-treating wafers according to another embodiment of the present invention.

### DETAILED DESCRIPTION

The present invention will now be described more fully hereinafter with reference to the accompanying drawings, in which preferred embodiments of the invention are shown. This invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the thicknesses of layers and regions are exaggerated for clarity. Like numbers refer to like elements throughout the specification.

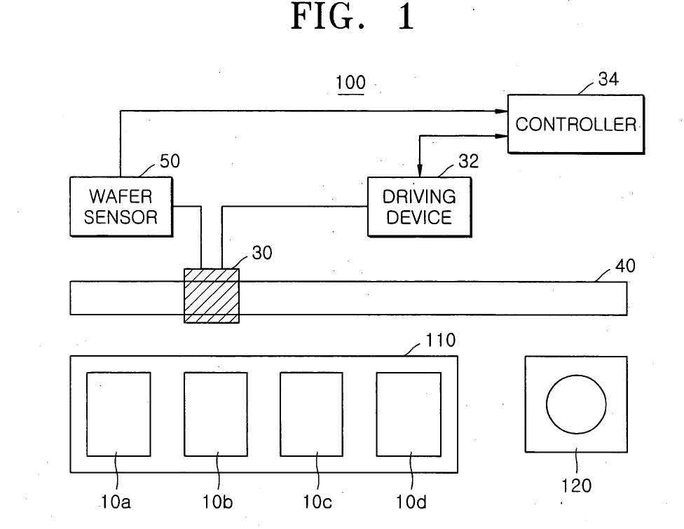

In FIG. 1, an apparatus for wet-treating wafers 100 according to an embodiment of the present invention comprises a chemical unit 110 including a plurality of wet treatment baths 10a, 10b, 10c, 10d for forming a chemical bath or a rinse bath, and a dry unit 120 for drying wafers as cleaned. A wafer transfer robot arm 30 is used for moving the wafers to each position of the wet treatment bath 10a, 10b, 10c, 10d and the dry unit 120. The robot arm 30 transfers one lot of wafers consisting of plural sheets of wafers along a predetermined movement line 40 to be loaded into the apparatus for wet-treating wafers or to be unloaded from the apparatus for wet-treating wafers. It also transfers the wafers to the wet treatment baths 10a, 10b, 10c, and 10d of the chemical unit 110 or to the dry unit 120 for progressing the next process in the apparatus for wet-treating wafers 100.

The wet treatment baths 10a, 10b, 10c, 10d may include, for example, a chemical bath for etching a predetermined layer on the wafers using a predetermined chemical or a cleaning bath for cleaning or rinsing the surface of the wafers.

A driving device 32 for driving the robot arm 30 is connected with a controller 34 and performs a driving operation in accordance with a command from the controller 34.

A wafer sensor 50 is connected with a robot arm 30. The wafer sensor 50 is installed at a predetermined location with respect to the robot arm 30, or adjacently to the robot arm 30, for sensing whether the wafers supported by the robot arm 30 were damaged while the robot arm 30 is moved.

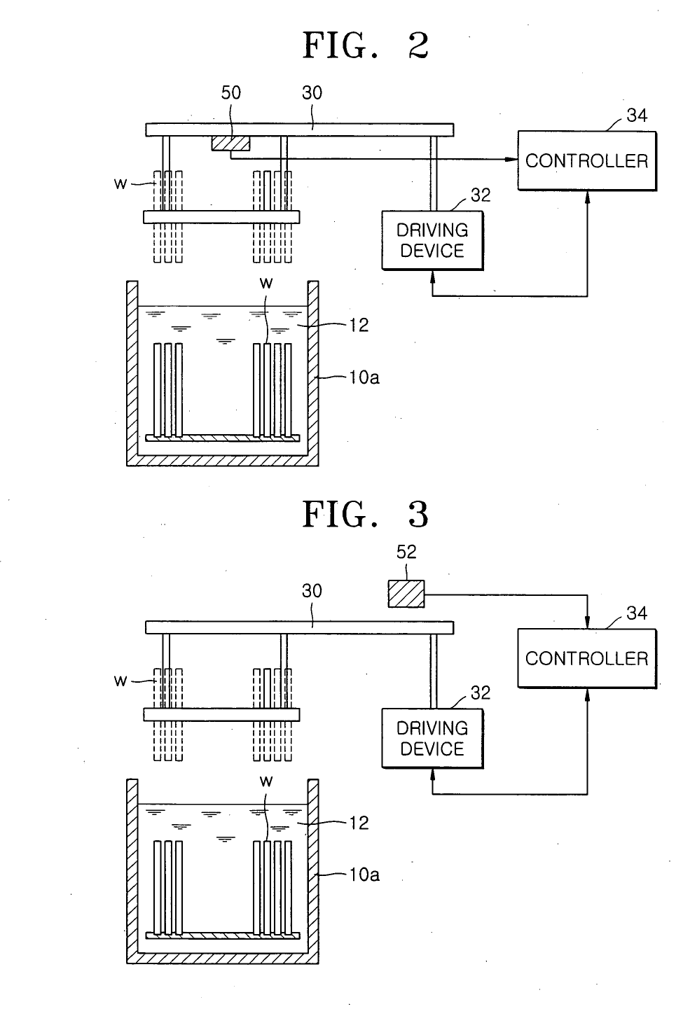

In FIG. 2, the wet treatment bath 10a includes a treatment solution 12 forming the chemical or cleaning solution for the wet treatment of one lot of wafers comprising a plurality of sheets of wafers (W). The wet treatment bath 10a is illustrated in FIG. 2. However, the other wet treatment baths 10b, 10c, 10d may be configured in the same manner. The wafer transfer robot arm 30 can be vertically and horizontally movable by the driving device 32, and is installed at one side of the wet treatment bath 10a. The wafer transfer robot arm 30 is provided with a wafer sensor 50 above the region where the wafers (W) are supported.

In one embodiment, the wafer sensor 50 may include an electronic device for detecting the weight of one lot of wafers supported by the robot arm 30. In this case, the wafer sensor 50 detects the weight of one lot of wafers supported by the robot arm 30 in order to sense whether the wafers supported by the robot arm 30 are damaged. Typically, this wafer weight detection procedure is carried on while the robot arm 30 is moved. The controller 34 compares the weight as sensed by the wafer sensor 50 to a reference data weight which is a predetermined weight of one lot of wafers. As a result of the comparison, it determines whether or not there are any faulty wafers present. If the weight as sensed is beyond the allowable range of the reference data, an interlock signal is generated to stop the movement of the driving device 32.

Further, in another embodiment, the wafer sensor 50 may include a charge coupled device (CCD) camera mounted at a predetermined position on the robot arm for detecting the image data of one lot of wafers supported by the robot arm 30. In this case, the wafer sensor 50 senses the image data of one lot of wafers supported by the robot arm 40 in order to detect whether the wafers supported by the robot arm 30 are damaged. Again, this can be done while the robot arm 30 is moved. The controller 34 compares the image data as sensed by the wafer sensor 50 to reference data which is predetermined image data of one lot of wafers. As a result of the comparison, it can be determined whether or not any damaged wafers are present. If the image data as sensed is beyond the allowable range of the reference data, an interlock signal is generated to stop the movement of the driving device 32.

FIG. 3 is a schematic view which illustrates the apparatus for wet-treating wafers according to another embodiment of the present invention. The reference numerals in FIG. 3 designate the same members in FIG. 2 and the description of the same members is therefore omitted.

The apparatus of FIG. 3 is on the whole similar to the apparatus of FIG. 2, except that wafer sensor 52 is not mounted within the confines of the robot arm 30 but at a predetermined position above the robot arm 30 spaced apart from the robot arm 30. For example, the wafer sensor 52 can be installed at a predetermined position, in this case above the robot arm 30, but it may be installed at another position, such as at the upper end of the chemical unit 110 (see FIG. 1). The wafer sensor 52 includes a CCD camera for detecting the image data of one lot of wafers supported by the robot arm 30. The wafer sensor 52 detects the image data of one lot of wafers supported by the robot arm 30 while the robot arm 30 is moved, compares the image data as sensed by the wafer sensor 52 to reference data which is predetermined image data of one lot of wafers, and as a result of the comparison, determines whether there are damaged wafers. If the image data as sensed is beyond the allowable range of the reference data, an interlock signal is generated to stop the movement of the driving device 32.

As described above, in the apparatus for wet-treating wafers according to an embodiment of the present invention, any one of the wet treatment baths 10a, 10b, 10c, and 10d can perform a predetermined wet treatment with respect to one lot of wafers consisting of a plurality of sheets of wafers in the wet treatment. This treatment can include etching, cleaning or rinsing of the wafers. Then, the one or more of the wet treatment baths 10a, 10b, 10c, 10d, or any equipment required for another process step, is moved by the wafer transfer robot arm 30. During the movement the wafer sensor 50 or 52 is used for sensing whether the wafers supported by the robot arm 30 are damaged. As the result of sensing whether the wafer is damaged while the robot arm 30 is moved, the controller 34 determines whether or not to allow the process to continue.

In determining whether or not to continue the process, the wafer sensor 50 or 52 can comprise an electronic device which can establish the regular weight of one lot of wafers as a predetermined reference data. After the wafer sensor senses the actual weight of one lot of wafers, the weight as sensed is compared to this predetermined reference data. If the weight as sensed is beyond the allowable range of the predetermined reference data, an interlock signal can be generated to control the input of the next lot of wafers into the wet treatment bath.

Further, in determining whether to continue the process, if the wafer sensor 50 or 52 includes the CCD camera, the regular image data of one lot of wafers is established as the predetermined reference data. After the wafer sensor senses the actual image data of one lot of wafers, the image data as sensed is compared to the reference data. If the image data as sensed is beyond the allowable range of the reference data, an interlock signal is generated to control the input of the next lot of wafers into the wet treatment bath.

The apparatus for wet-treating wafers according to an embodiment of the present invention includes the wafer sensor installed on the robot arm, or adjacent to the robot arm, for sensing whether the wafers supported by the robot arm are damaged. While the robot arm is moved, after the wet treatment is finished in the wet treatment bath, the weight or image data of the wafers can be sensed and the data before and after the wafers are input into the wet treatment bath can be compared. Likewise, while the robot arm is moved, the wafer sensor senses whether the wafer are damaged and, as a result, the controller determines whether or not to prevent the next lot of wafers from being input. Accordingly, even if any damage has occurred to the wafers in the wet treatment with respect to one lot of wafers, and a portion of the damaged wafer remains in the wet treatment bath, the wafer sensor senses such a condition while the robot arm is moved. It can then determine whether or not to input the next lot of wafers, thereby preventing any large scale accidents.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for wet-treating wafers comprising:
at least one wet treatment bath for wet treating a plurality of wafers;
a wafer transfer device for moving the plurality of wafers to the wet treatment bath;
a wafer sensor for sensing data comprising the weight of the plurality of wet-treated wafers; and
a controller for determining whether any of the plurality of wet-treated wafers supported by the wafer transfer device are damaged by comparing the data as sensed by the wafer sensor to data regarding a predetermined weight of a plurality of reference wafers.

2. The apparatus of claim 1, wherein said wafer transfer device comprises a robot arm.

3. The apparatus of claim 1, wherein said wafer sensor is located adjacent to or connected to said wafer transfer device.

4. The apparatus of claim 1, wherein the wafer sensor comprises an electronic device mounted at a predetermined position with respect to the wafer transfer device for detecting the weight of a plurality of wet-treated wafers supported by the wafer transfer device while the wafer transfer device is moved.

5. The apparatus of claim 1, wherein the controller, after comparing the sensed data with the reference data, generates an interlock signal.

6. The apparatus of claim 1, wherein the wafer sensor comprises a charge coupled device camera mounted at a predetermined position with respect to the wafer transfer device.

7. The apparatus of claim 1, wherein the wafer sensor is mounted at a predetermined position above the wafer sensor.

8. The apparatus of claim 1, wherein the wet treatment bath comprises at least one of a chemical bath for etching a predetermined layer on the wafers and a cleaning bath for cleaning or rinsing the surface of the wafers.

9. A method for wet-treating wafers comprising:
wet-treating a plurality of wafers in a wet treatment bath;
moving said wet-treated wafers from the wet treatment bath;
sensing and generating data as to whether the wet-treated wafers are damaged; and
determining the relative condition of the wet-treated wafers and ascertaining whether they are damaged by comparing the data as sensed by the wafer sensor to data regarding the condition of reference pre-treated wafers.

10. The method of claim 9, wherein the wet treatment bath is a chemical bath for etching a predetermined layer on the wafers.

11. The method of claim 9, wherein the wet treatment bath is a cleaning bath for cleaning or rinsing the surface of the wafers.

12. The method of claim 9, wherein determining the relative condition of the wet-treated wafers comprises detecting a change in the weight of the wafers as compared to the weight of the reference wet-treated wafers to detect whether the wafers are damaged.

13. The method of claim 12, wherein an electronic device mounted at a predetermined position while the wet-treated wafers are moved is used to detect the change in the weight of the wet-treated wafers.

14. The method of claim 9, further comprising detecting image data of the wet-treated wafers to detect whether the wet-treated wafers are damaged.

15. The method of claim 14, wherein a charge coupled device camera is installed at a predetermined position to detect the image data.

16. The method of claim 14, wherein a charge coupled device camera is installed at a predetermined position above the wet-treated wafers to detect the image data.

17. The method of claim 9, wherein the operation of ascertaining whether the pre-treated wafers are damaged further comprises:
establishing a predetermined weight of wafers as reference data;
sensing an actual weight of a plurality of wet-treated wafers; and
comparing the actual weight as sensed to the reference data.

18. The method of claim 17, further comprising generating an interlock signal if the weight as sensed is beyond an allowable range as compared to the reference data.

19. The method of claim 9, wherein the operation of determining whether or not any troubles further comprises:
establishing predetermined image data of wafers as referenced data;
sensing actual image data of the wet-treated wafers; and
comparing the image data as sensed to the reference data.

20. The method of claim 19, further comprising generating an interlock signal if the image data as sensed is beyond an allowable range as compared to the reference data.
